(19) United States
(12) Patent Application Publication
(10) Pub. No.: US 2007/0297408 A1
(43) Pub. Date: Dec. 27, 2007

(54) Message control system in a shared hosting environment

(76) Inventors: Jooyong Kim, Des Plaines, IL (US); Jason Michael Abate, Chicago, IL (US); Vito Anthony Caputo, Wheaton, IL (US); Shapor Edmund Naghibzadeh, Niles, IL (US); Philip James Freeman, Harwood Heights, IL (US); Youngbae Oh, Seoul (KR)

Correspondence Address: BRINKS HOFER GILSON & LIONE, P.O. BOX 10395, CHICAGO, IL, 60610, US

(21) Appl. No.: 11/472,851

(22) Filed: Jun. 22, 2006

(51) Int. Cl. H04L 12/56

(52) U.S. Cl. 370/392; 370/401

(57) ABSTRACT

In a shared hosting environment, a message sender is identified based on a system identification of the sender. The system identification is controllable and accessible in the shared hosting environment. Properties of the message are evaluated based on a predetermined rule. The message is distributed upon compliance of the message with the rule.

### BACKGROUND OF THE INVENTION

1. Technical Field

This invention relates to a message control system and in particular, to a message control system in a shared server environment.

2. Related Art

Hosting service providers supply internet services to users who desire to establish their presence on an internet. Internet services include, for example, web hosting services, email services, file transfer protocol (FTP) services, etc. Hosting service providers may be internet service providers that provide an internet access to clients. Alternatively, hosting service providers may focus on more professional hosting services after users have access to the internet. Users may rent a space in a server operated by hosting service providers. Using the rented space, users may store data, run websites, and/or send various types of messages, such as emails, voice over internet protocol (VOIP) messages, and instant messenger (IM) messages, etc.

Hosting service providers may need to control prohibited use of hosting services. For instance, the prohibited use of hosting service includes sending spam emails, distributing unlawful contents such as child pornography, blackmailing, Denial of Service (DoS) attack etc. Hosting service providers may need to stop this prohibited use to protect other users and comply with laws.

It may not be easy to identify users who engage in the prohibited use of hosting service. Such users do not desire to reveal their identities and may try to hide or forge their identities. Users who engage in the prohibited use of hosting services may know sophisticated techniques to hide their identities. In a hosting service environment, a number of domains may share a single hosting server. For a practical reason, a number of domains may share one internet protocol (“IP”) address. Users who plan to send spam messages, perform DoS attack, or distribute unlawful content (collectively, referred to as “spammer” hereinafter) may take advantage of the shared IP address. In particular, spam control is often performed on a recipient side. One well-known spam control technique includes identifying the source IP address of a sender. With the shared IP address, non-spammers and a spammer may use the same IP address. As a result of the IP address screening, non-spammer users may be mistakenly exposed as a spammer.

If the shared IP address may be recognized as a spam source, a non-spammer may be mistakenly identified and registered as a spammer. Once a non-spammer is mistakenly identified as a spammer, non-spammers may experience blocking of message services. This mistaken identification may repeatedly cause inconvenience to non-spammers and non-spammers may end up discontinuing a particular hosting service. The quality of hosting service also may be degraded. A hosting service provider may be registered as a spammer. This may result in impact on all customers of a particular hosting service, regardless whether customers share the same IP address with an actual spammer.

In addition to email spam, VOIP spam or IM spam starts to appear. VOIP or IM messages are transmitted in a way similar to email messages. If Session Initiation Protocol may be used for the VOIP system, VOIP spam may be generated in the same manner as email spam. Any open, IP-based phone system may be an easy target for VOIP spam. VOIP or IM spam potentially incurs more serious problems than email spam because messages are large in size. VOIP spam or IM spam may be more time consuming and irritating for recipients to handle than email spam. Thus, there is a need for a message control system in a shared hosting environment that overcomes drawbacks of the prior art.

### SUMMARY

In one embodiment, in a shared hosting environment, a message sender is identified based on a system identification of the sender. The system identification is controllable and accessible in the shared hosting environment. Properties of the message are evaluated based on a predetermined rule. The message is distributed upon compliance of the message with the rule.

In other embodiment, a message control system in a shared hosting environment is provided. The message control system includes a server and a message control agent. The server is shared by a plurality of virtual hosts. The server includes an identification module which identifies a user ID. The message control agent is in communication with the identification module and determines distribution of messages based on the user ID. The user ID is generated at an operating system level of the server and corresponds to a message data packet generator.

In another embodiment, a message control system in a shared hosting environment includes a hosting server, an interface and a message control agent. The hosting server includes a first and a second layer. The interface operates to export information generated at the second layer into the first layer. The message control agent operates to identify a message sender based on the information exported via the interface. The message control agent evaluates properties of a message. The message control agent is configured to reside at the first layer.

In further another embodiment, a message control system in a shared hosting environment includes a server, a first message control agent, and a second message control agent. A plurality of virtual hosts shares the server. The first message control agent operates to identify a user ID. The second message control agent is in communication with the first message control agent. The second message control agent determines distribution of messages based on the user ID.

In further another embodiment, a shared hosting system includes a plurality of users, a hosting server and a message control agent. The users have a first identification and a second identification. The first identification is modifiable by the users. The second identification is transparent to the users. The hosting server maintains the second identification associated with the users. The message control agent operates to distribute messages upon verification of the users based on the second identification.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram illustrating one embodiment of a shared server environment.

FIG. 2 is a block diagram illustrating a first embodiment of a message control system.

FIG. 3 is a flowchart illustrating message control of the first embodiment.

FIG. 4 is a block diagram illustrating a second embodiment of a message control system for use with a shared server environment.

FIG. 5 is a block diagram illustrating a third embodiment of a message control system for use with a shared server environment.

FIG. 6 is a block diagram illustrating a fourth embodiment of a message control system for use with a shared server environment.

FIG. 7 is a block diagram illustrating a fifth embodiment of a message control system for use with a shared server environment.

### DETAILED DESCRIPTION OF THE PREFERRED EMBODIMENTS

One of the prohibited uses of hosting service includes spam. Spam is well known as unsolicited emails or junk/bulk emails. Spam is not limited to emails and may include other types of messages such as VOIP messages, IM messages, web posting messages, and any messages or packets for Denial of Service (DoS) attack. DoS attack involves loss of service and/or connectivity of a network by consuming the bandwidth of that network, or overload of a computer system. Spam may include commercial advertisements, unlawful contents such as blackmailing, child pornography, etc. Accordingly, spam as referred to herein below indicates any type of unwanted messages in electronic form.

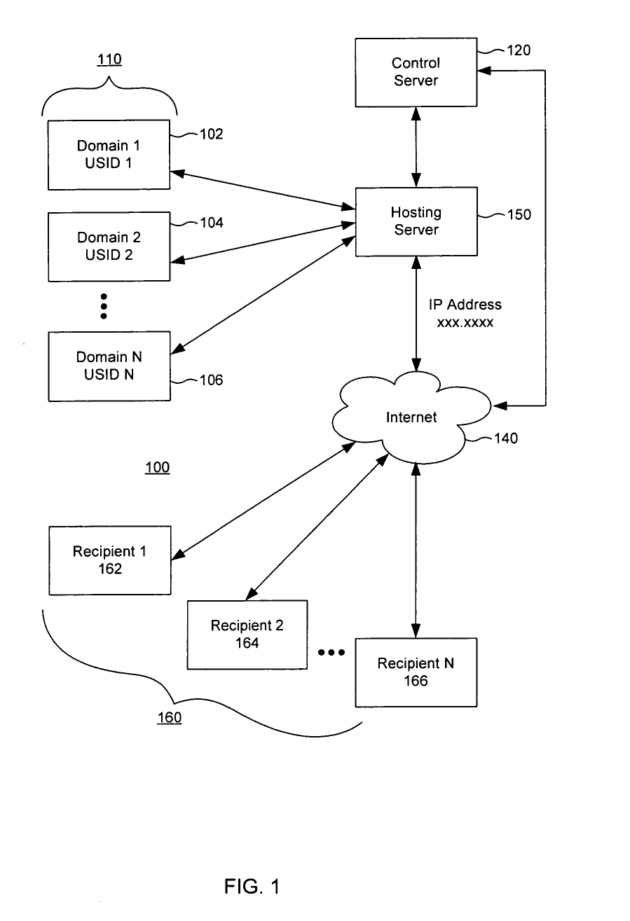

FIG. 1 is a block diagram illustrating one embodiment of a shared hosting environment 100. The shared hosting environment 100 includes a plurality of users 110, a control server 120, a hosting server 150, and a recipient 160. The components of the shared hosting environment 100 communicate using a variety of networks and channels such as internet 140. A hosting service provider may operate and control the control server 120 and the hosting server 150. A hosting service provider has unlimited access to the control server 120 and the hosting server 150. The control server 120 and the hosting server 150 may be any type of data processing device. The control server 120 may manage hosting service, and the hosting server 150 may provide service to the users 110. In FIG. 1, one control server 120 and one hosting server 150 are illustrated but the shared hosting environment 100 may include more servers.

In the shared hosting environment 100, each user may be assigned with a user account. Each user may correspond to a virtual host of the hosting server 150 and a user account is used to manage contents of the virtual host. In the shared hosting environment 100, the users 110 and user accounts may be associated via a mapping. The hosting server 150 supports, for example, five hundred virtual hosts to run websites, send email messages, etc. A virtual host is labeled as a domain name to communicate with the internet 140.

Software applications running on the hosting server 150 have context. Context is the circumstance where software applications run. Accordingly, any activity and execution of programs may be performed under context. For example, particular programs and context may be tied up based on appropriate mechanism such that when a user runs particular programs, a user's activity is associated with context. The users 110 login with the hosting server 150. After login, any activity by the users 110 is associated with user accounts of the users 110. In other words, any activity by the users 110 is performed under context of user accounts. Context of the user accounts includes information that relates to permission and privilege of using the hosting server 150. For example, context of the user accounts includes a user ID that is used for checking permission and privilege.

The users 110 may be identified with a first identification and a second identification. The first identification may be controllable and selectable by a user. The first identification may be modified, changed, and even forged by a user. To the contrary, a user may have no control to the second identification. The second identification may effectively identify a user even when a user desires to hide the identity. The first identification includes application level information that users create. For example, the first identification includes sender information in a mail header. The second identification includes a user ID in context.

In FIG. 1, the users 110 may be identified with two different names, i.e., domain names, and user IDs. The domain names are used to represent the users 110 on the internet 1. For example, when the users 110 send email messages, identification corresponding to domain names may be used in a mail header. In some cases, such identification in the mail header may represent forged identifications. For example, a spammer among the users 110 can easily forge sender information in a mail header. To the contrary, the user IDs included in context may not be modifiable by a third party unless that third party has a full access to the administration of user accounts. The user IDs may be reliable information to identify an accurate identity of a user.

By way of example, in FIG. 1, user 1 and user 2 use hosting service from the hosting server 150. The user 1's domain name is Domain 1 and when the user 1 sends an email message, the user 1's identification appears as xxx@Domain1.com. The user 2 is a spammer and plans to send spam email. The user 2 desires to hide the identity and forges his domain name. When the user 2 sends spam email, the user 2 can forge sender information in a mail header as xxx@Domain1.com. Because the user 1 and the user 2 share the same IP address in the shared hosting environment 100, even a sophisticated recipient may not distinguish the user 2 from the user 1 based on the domain name. User 3 sends an email and is able to use a different domain name for convenience. For example, the user 3 desires to receive all messages by using a particular email address. The sender information in the mail header, in which the user 2 forges and the user 3 changes, corresponds to application level information. The application level information may be changeable and/or forgeable. Changing and/or forging the application level information may differ based on protocols used. Message control based on the application level information may be unreliable.

The user 2, however, may not forge the user ID. The user 2 can send emails with two different methods. The user 2 sends emails with exported programs by sending a web request, for example, http://www.domain2.com/cgi-bin/sendmailtocustomers.cgi. In this case, web server may be configured to tie the program and context of a user account. With that configuration, web applications for a virtual host may be running under a specified user account's context. Alternatively, the user 2 logs in the hosting server 150 and runs an email application. In any case, the user 2 runs software applications under context of the user account. As described above, context of the user account includes the user ID of the user 2. As long as the user 2 is associated with context of the user account, the user ID remains unchanged and exposed. Accordingly, the user ID may serve as more reliable identification tool.

The user IDs may be automatically generated by an operating system, or may be determined by a system administrator of the hosting server 150. The hosting server 150 and an operating system recognize the user IDs whenever a particular user performs any activity through the hosting server 150 after login into a particular user account. As long as a user operates under context of that user account, a user can be identified with the user ID. The user IDs may be in a particular form that an operating system understands. For example, the user IDs may be numeric form. By way of example only, a username of the user account is jksmith and the user ID is 501.

By using the example, the domain name of the user may be jksmith.com according to the users' desire or convenience. Even if a user may change identification by changing sender information to zzz@jkrobert.com, such change does not affect the user ID. When a user logs in to the exemplary user account having the name of jksmith, a user's activity is performed under context of jksmith and an operating system identifies the user ID 501 associated with the jksmith account. When a user sends messages such as email messages, VOIP message, etc., data packets are generated. In those cases, an operating system associates a packet generator with the user ID. As a result, tasks are automatically associated with the exemplary user ID, 501. In other words, an operating system knows that a user ID 501 is performing certain tasks.

As noted above, the user IDs in contexts or kernel data structures are not changeable, modifiable and forgeable by the users 110. The user IDs are generated and managed beyond the users' control. A system administrator of the hosting server 150, on the other hand, has full control and access to the user IDs. When the user 1 sends an email, he or she generates packets inside the hosting server 150. The operating system is able to identify the user ID in context, or from kernel's internal data structure generated by software applications. For example, when a certain program sends data packets into the network, an operating system may identify a packet generator by checking the socket owner from which the packets come.

Using the user ID to control a message may provide advantages when a spammer tries to hide or forge an identity. Because even a sophisticated user cannot forge the user ID, the user ID may be relied on to control spam messages. Using the user ID may provide cost effective message control to a hosting service provider. The user ID may be related to functionality of an operating system. Accordingly, additional equipment and/or applications may not be needed to utilize the user ID. To provide a better interface to a system administrator, optional software applications may be used.

A hosting service provider who has complete access and control may check the user ID of a user who is currently generating data packets. As will be described below, the user ID may be encrypted even for internal communications between the hosting server 150 and the remote control server 120. The encryption may protect the data packets from possible intercept and manipulation.

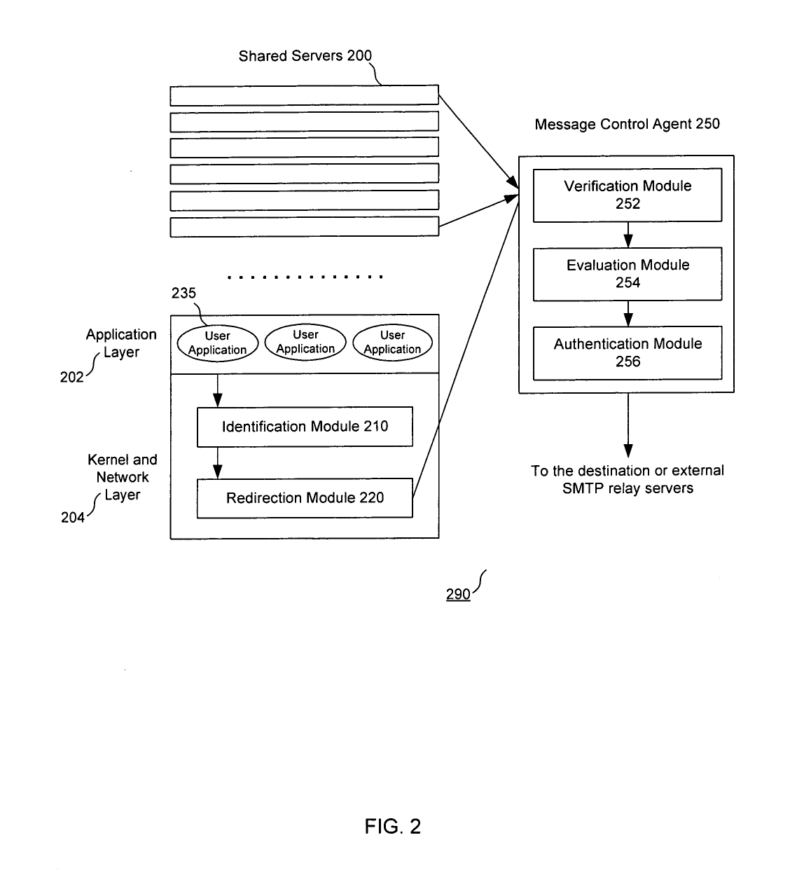

The identified user IDs are processed to be associated with the generated packets. For example, the identified user IDs may be tagged into the packets. The generated packets are sent to the control server 120 for verification, authentication, content filtering, distribution, etc. The control server 120 may be a remote server. The control server 120 may take advantage of the identified user IDs. If a user tries to send a message, the control server 120 may include a message control agent, which will be described in detail in conjunction with FIG. 2 below.

The control server 120 and the hosting server 150 are in communication with the internet 140. The control server 120 may ultimately determine that a message generated by the identified user is distributed to the recipient 160. The control server 120 takes into consideration a predetermined rule or policy to make such determination. Alternatively, the control server 120 may check into a list of users who have been identified or suspected as a spammer.

FIG. 2 is a block diagram illustrating a first embodiment of a message control system 290. A hosting service provider operates a plurality of hosting servers 200. The hosting server 200 includes an application layer 202 and a kernel and network layer 204. At the application layer 202, user applications 235 are stored and maintained. For example, the user applications 235 may be used to send messages to external mail servers. At the kernel and network layer 204, the hosting server 200 includes an identification module 210 and a redirection module 220.

The identification module 210 operates to identify the user IDs, USID1, USID2 . . . USIDN. The identification module 210 may retrieve a user ID by checking the socket owner generating data packets or from the context of the application. Alternatively, the identification module 210 checks a currently occupied IP and port number pair and a user ID occupying that pair. Because the identification module identifies a user with a user ID from context or kernel data structure, an accurate identity of a user may be detected, regardless of any attempt to forge or change an identity by a user.

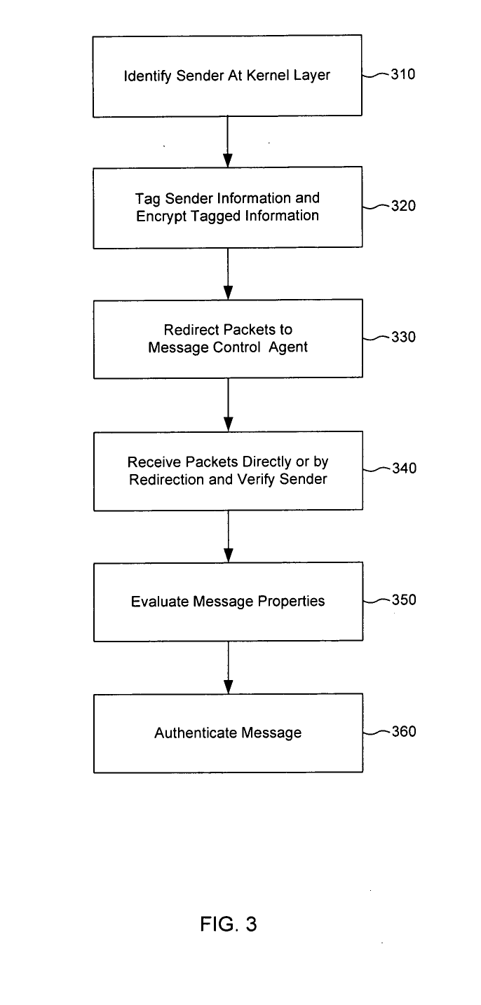

The kernel and network layer 204 includes the redirection module 220. The redirection module 220 operates to redirect messages to a message control agent 250. The redirection may not always occur. The redirection may be performed in a case where a user tries to send messages by using an external message transfer agent (“MTA”). A hosting service provider may not have any control over the external MTA. The redirection module 220 ensures that a hosting service provider checks any message before it is distributed. The operation of the redirection module 220 will be described in detail below in conjunction with FIG. 3.

The message control agent 250 is in communication with the servers 200. The message control agent 250 receives message packets from the servers 200. The message control agent 250 may be an independent server, software applications residing in a server, or both. In this embodiment, the message control agent 250 is located in a remote server such as the control server 120. Alternatively, the message control agent 250 may be located in a local server such as the hosting server 200. The message control agent 250 includes a verification module 252, an evaluation module 254, and an authentication module 256. The message control agent 250 operates to make a determination as to distribution of messages with the evaluation module 254. The message control agent 250 verifies a user's identity with the verification module 252 and authenticates messages with the authentication module 256. Messages output from the message control agent 250 are sent to the recipient 160 of FIG. 1 or external servers such as SMTP relay servers. SMTP stands for simple mail transfer protocol, as well known in the art.

FIG. 3 is a flowchart illustrating message control with the hosting server 200 in the shared hosting environment. For convenience of explanation, one of the users plans to send an email message. This user is referred to as “the sender” hereinafter. As noted above, the sender may use applications available via a remote network interface, for example, a web application exposed via Hypertext Transmission Protocol (HTTP), or the sender may directly use applications after logging into the hosting server 200. Regardless of how the sender emails are configured to be generated, the sender's emails are sent under context of the sender's user account. For example, applications that the sender is using and the sender's user account may be configured to be tied up such that the sender's activity on applications may be recognized under context of the user account. In FIG. 3, the sender is identified by the hosting server 200 (310). The user ID is contained in context or kernel data structure and retrieved by the identification module 210.

When the sender sends an email message, packets are generated at the kernel and network layer 204 of the hosting server 200. The sender is identified with the sender's user ID. An operating system is able to check a packet generator and retrieve the sender's ID by using internal kernel data structure such as a socket structure. For example, an operating system such as Linux can retrieve the sender ID by checking the owner of the socket from which the packet is sent. Even if the sender forges the sender information in the mail headers, the sender's user ID is not affected. As long as the sender generates the packet under context of the user account, the sender may be accurately identified.

Information on the identified sender may be processed so that the information is always associated with the packets generated by the sender. This association allows other components of the hosting environment such as the control server 120 (FIG. 1) to use the sender information. The sender information is tagged into the packet (320). The sender information may be tagged as application data such as SMTP headers, or MIME (Multipurpose Internet Mail Extension) headers. In other embodiments, the sender information may be tagged into packet headers, including TCP/IP headers. TCP stands for Transmission Control Protocol and IP stands for Internet Protocol.

The tagged information may be encrypted with a secret key (320). When the tagged information is sent to a remote server, the encryption may protect the sender information from possible hacking. The sender sends an email message via the message control agent 250. The sender also may send an email message by using an external mail transfer agent (MTA). The redirection module 220 may redirect packets to the message control agent 250. Data packet redirection may be performed with network address translation (“NAT”). The NAT technique may change source and/or destination IP addresses of a data packet. The NAT technique may be used to format a source address and/or a destination address of incoming and outgoing data packets. To redirect the packets to the message control agent 250, the redirection module 244 may format a destination address of outgoing data packets. In other words, the redirection module 244 may format a destination address of an external MTA to a destination address of the message control agent 250. As a result, the data packet will be redirected to the message control agent 250. For the packets directed to the message control agent 250, redirection does not occur.

The data packets are sent to the message control agent 250, either directly or by redirection. The message control agent 250 receives the data packet and verifies the sender (340). As noted at 320, the sender information including the user ID at the hosting server may be tagged into the data packet and the data packet is encrypted. Additionally, and the identification of the hosting server 200 may be tagged into the data packet. Verification of the sender may require decryption of the tagged information. After decryption, the sender information is retrieved. After retrieving the sender information, the message control agent 250 is able to know the sender's domain name. The sender's user ID and the domain names may be mapped.

The message control agent 250 evaluate message properties (350). The message control agent 250 may define predetermined rules or policy regarding message distribution. The rules or policy may include a plurality of check items for each message before a message is distributed. This may ensure that spam messages will not be distributed. For example, the check items may include numbers/rate of messages, recipients, number/rate of connections, a number of concurrent connections, content-based filtering, etc.

By way of example, the message control agent 250 applies the following limitations to an email message of the sender:

| Check Items | Limitation |
|---|---|
| Number/rate | The sender cannot send more than ten email message per |
| of messages | second. |
| Recipients | If the sender sends one email message to ten different |
| | recipients, the sender is treated to send ten email |
| | messages. |
| Number/rate of | It is determined whether the sender sends ten email |
| connections | messages with a single connection. |
| | The sender is limited to open five or less connections per |
| | second. |
| Content-based | It is determined whether the sender's email message |
| Filtering | contains commercial advertisements or unlawful |
| | contents. |

The check items are not limited to the foregoing table and any other check items which are used for spam control technique may be added. The message control agent 250 may report the above checked items to an accounting server for billing purposes.

The message control agent 250 determines whether the sender violates any check item defined by the rule or policy (350). If the sender complies with each check item, the message control agent 250 determines distribution of the sender's message. The message control agent 250 may authenticate the sender's message for the distribution (360). The message control agent 250 may preserve authenticating keys of a particular hosting service provider and assign them to the sender's message. With the keys, an email message of the sender is authenticated. A recipient of this email message is able to detect existence of the keys and determines that this email message is not spam. The message control agent 250 may use any other sender authentication mechanisms proposed by third party companies.

Upon determination that the sender violates the check items, the message control agent 250 may block distribution of an email message by the sender. The sender may be notified of the blocking of an email message. The sender may be recorded as a spammer. The message control agent 250 may check whether the sender repeatedly attempts to send email spam messages.

Based on the above, spam messages may be prevented from distribution by the sender's server. The sender's server is able to determine an accurate identity of the sender. Other non-spamming users may be protected from being mistakenly identified as a spammer even if they share the same IP address. No additional equipment, application, and/or processes may be needed. Based on full access and control over the hosting server, a hosting service provider is able to provide spam-free service environment.

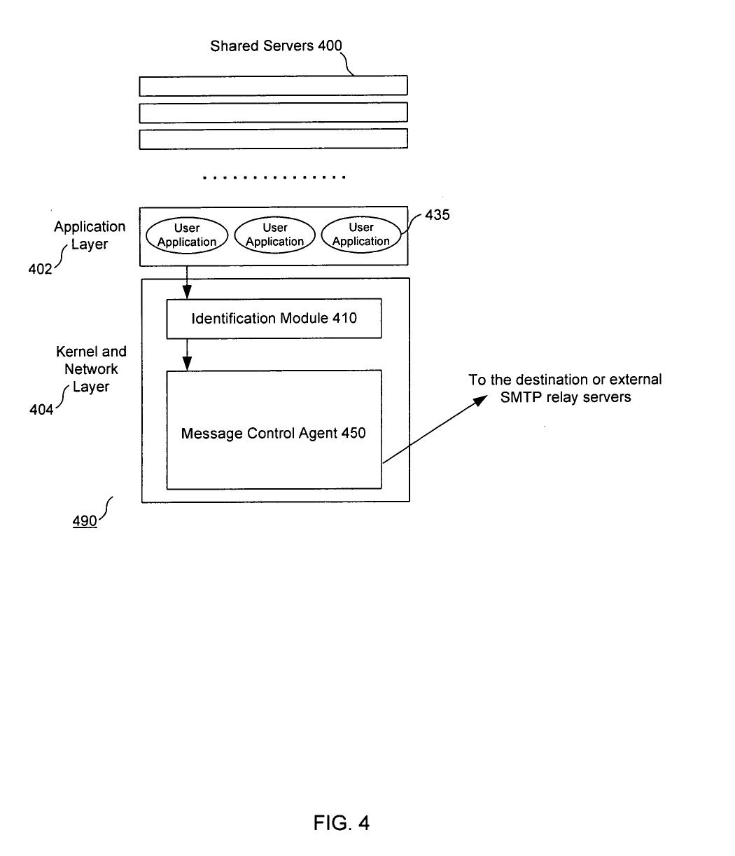

FIGS. 4-7 illustrate different embodiments in which a message control agent is located in a hosting server and/or two message control agents engage in message control. The different embodiments may perform identification, evaluation and/or authentication tasks at a different part of hosting servers. The different embodiments may not include a redirection module or a tagging module. In particular, a message control agent may be located at a hosting server rather than a remote server. A message control agent is disposed at an application layer or a kernel layer.

FIG. 4 is a block diagram illustrating a second embodiment of a message control system 490. A hosting server 400 includes a message control agent 450. In FIG. 2, the message control agent 250 is located at a remote server from the hosting server 200. In this embodiment, the hosting server 400 includes the message control agent 450 at a kernel and network layer 404, as shown in FIG. 4. User applications 435 are stored at the application layer 402, as described above in connection with FIG. 2. Although not shown, the message control agent 450 includes various modules such as an evaluation module and an authentication module.

In operation, the sender is identified with the user ID by an identification module 410. The identification of the user ID is performed as described above in connection with FIG. 3. In this embodiment, this user ID may not be tagged with data packets. Because the message control agent 450 resides at the kernel and network layer 404, the user ID is not tagged. An encryption of the user ID is also not performed. Furthermore, a redirection module is not present because data packets are generated at the kernel and network layer 404 and the message control agent 450 is able to check the data packets. The message control agent 450 is able to perform this task, regardless of destination addresses of the data packets. In the first embodiment, because the message control agent 250 is located at a remote place, the redirection of the data packets may be performed depending on the destination address of the data packets. The message control agent 450 verifies the sender and evaluates message properties in view of the check item contained in the rules or policy. Upon compliance, the message control agent 450 authenticates an email message with an assigned authenticating key.

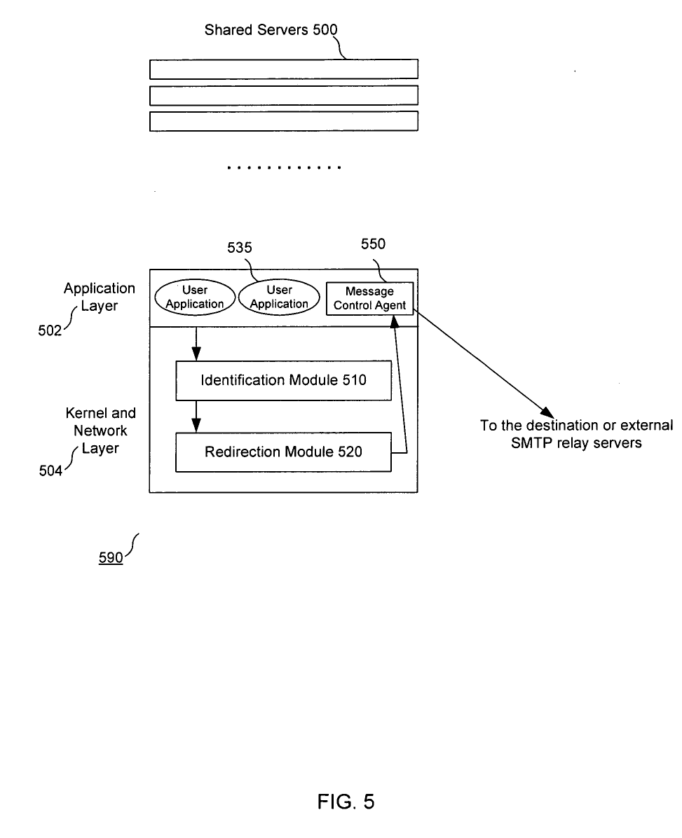

FIG. 5 is a block diagram illustrating a third embodiment of a message control system 590. A hosting server 500 includes a message control agent 550 at an application layer 502. At a kernel and network layer 504, the hosting server 500 includes an identification module 510 and a redirection module 520. The message control agent 550 may be a local application, as opposed to the remote message control agent 220 of FIG. 2.

The hosting server 500 operates as follows. The sender's user ID is checked as data packets are generated at the identification module 510. The identified user ID is tagged into the generated packets at the identification module 510. Because the message control agent 550 is disposed at the application layer 502 rather than the kernel and network layer 504, tagging of the user ID facilitates the message control agent 550 to read the user ID. In the second embodiment, the message control agent 450 is disposed at the kernel and network layer 404. In this case, no tagging is performed as noted above. These packets are redirected to the message control agent 550 by the redirection module 520. The destination NAT technique may be used to format destination address with that of the message control agent 550. Unlike the second embodiment, the redirection is performed because the email message is intercepted for the message control by the message control agent 550. The destination addresses of some data packets may be addresses of external mail transfer agents rather than that of the message control agent 550. For those cases, redirection of the data packets is performed. The message control agent 550 performs the operation as described above in connection with the message control agent 220 of FIG. 2.

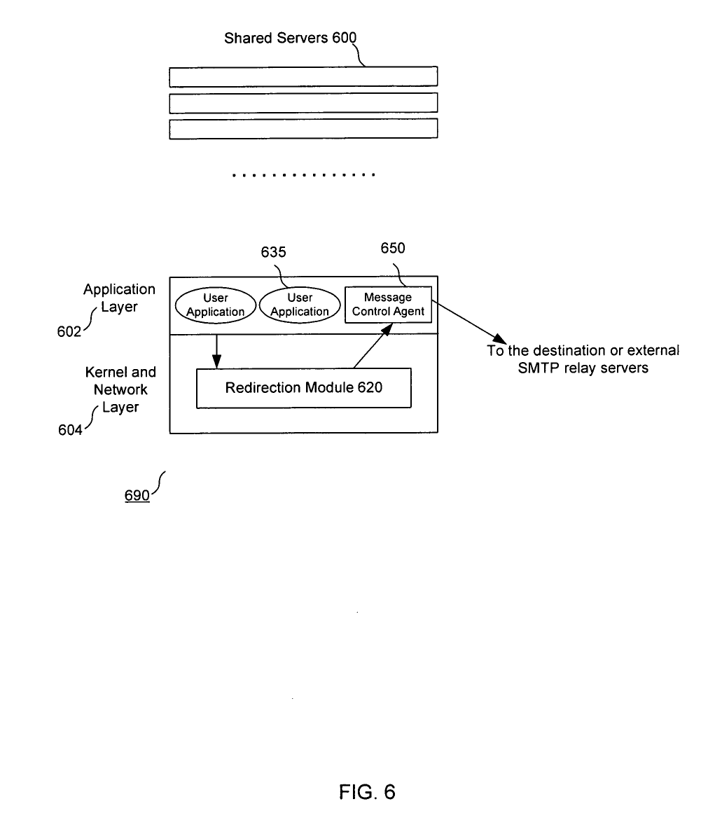

FIG. 6 is a block diagram illustrating a fourth embodiment of a message control system 690. A hosting server 600 includes a message control agent 650 at an application layer 602. At a kernel and network layer 604, a redirection module 620 is located. An identification module may not be disposed at the kernel and network layer 604 because the identification is performed at the message control agent 650. For this reason, the message control agent 650 may have interfaces for some kernel functions to identify the user ID.

The message control agent 650 is located at the application layer 602. When data packets are generated by the sender at the kernel and network layer 604, the message control agent 650 may have a kernel interface. The kernel interface allows the message control agent 650 to know the packet generator and identify the sender's user ID. One example of the kernel interface uses “connection information” to identify the user ID. When the sender tries to send an email message, the sender is occupying a particular IP and port pair. This connection information may be checked by an operating system at the kernel and network layer 604. The connection information is directly associated with the user ID. In other words, it shows who is occupying a particular port. The kernel interface provides the message control agent 650 with the user ID by using the connection information. No tagging of the user ID is performed in this embodiment because the kernel interface provides the user ID to the message control agent 650. This embodiment is applicable for the message control agent 650 which locally resides at the hosting server 600.

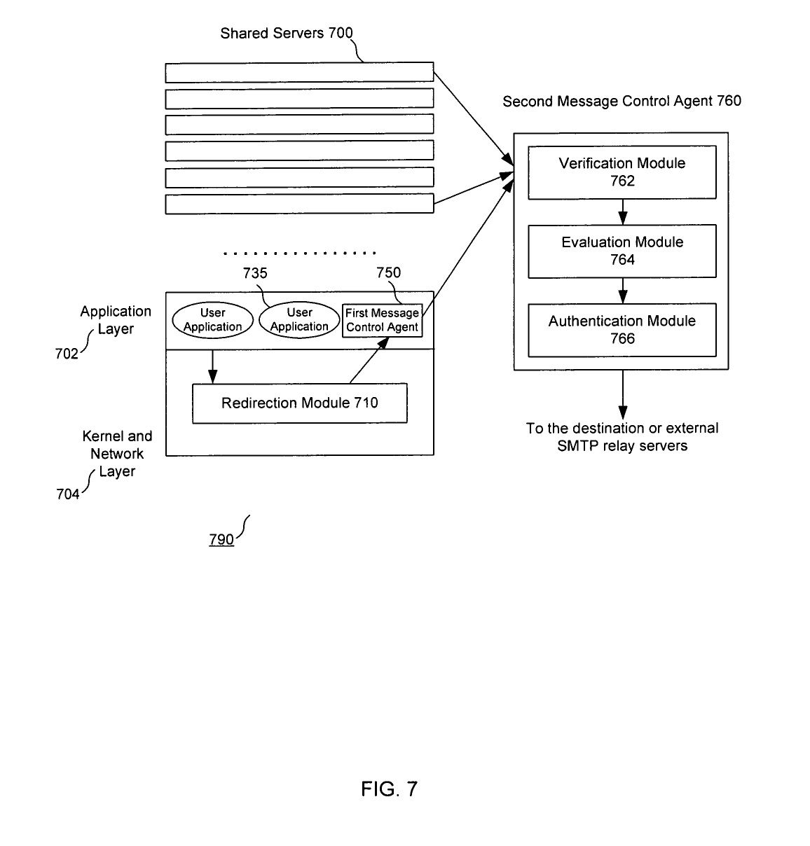

FIG. 7 is a block diagram illustrating a fifth embodiment of a hosting server 790. The hosting server 700 includes a first message control agent 750 and a second message control agent 760. In this embodiment, the first message control agent 750 engages in identification of the user ID of the sender and the second message control agent 760 engages in message control. The first message control agent 750 is local and the second message agent 760 is remote from the hosting server 700. At an application layer 702 of the hosting server 700, user applications 735 are stored. The first message control agent 750 is also located at the application layer 702. The second message control agent 760 includes a verification module 762, an evaluation module 764 and an authentication module 766. A kernel and network layer 704 includes a redirection module 710. The redirection module 710 operates to redirect messages to the first message control agent 750 in a case where the sender tries to use an external SMTP server. The destination NAT technique is used for the redirection.

In the fifth embodiment, a message control is operated as follows. The first message control agent 750 identifies the sender's user ID. As described above in conjunction with the fourth embodiment, the kernel interface may be used to provide the first message control agent 750 with the user ID. The identified sender ID is tagged into data packet generated and provided from the first message control agent 750 to the second message control agent 760. Encryption may be performed for transferring the data packets to the second message control agent 760.

The second message control agent 760 verifies the received user ID of the sender, evaluates the properties of the received message based on the check items, and may authenticate the message with keys upon verification and compliance of the check items, as described above in connection with FIG. 3.

As described above, the unchangeable user ID is recognized for generation of data packets. This user ID is effective to identify the user account and eventually a virtual host that the email is sent. An email message is distributed only after the sender's identity is verified and it is determined that a message complies with the predetermined rules. Other non-spammer users who share the IP address with a spammer may be protected from mistaken identity and any interference of email delivery service.

The foregoing embodiments are described with email messages. However, it is not limited to email messages and is applicable to voice over internet protocol (VOIP) messages, instant messaging (IM) messages, web posting messages to blog or web boards, any type of DoS messages or packets, etc. In a shared hosting environment, the users 110 (FIG. 1) are able to use their accounts to generate such spam messages. A hosting service provider may support the users 110 to utilize VOIP, IM, web posting, or DoS messages. Some sophisticated users 110 may install software that generates VOIP messages or IM messages.

As described above in connection with an email message, VOIP messages or IM messages may be prevented from distribution at a hosting server if they may be considered as spam. A sender's user ID is identified as packets are generated for VOIP messages or IM messages. This user ID is tagged with the data packets. A message control agent screens the properties of VOIP or IM messages to ensure that these messages are not spam prior to distribution. The message control agents described above in the embodiments may perform these tasks. Check items applicable to email messages may be applicable to VOIP or IM messages.

Arbitrary outbound network traffic may be originated from a shared server. For example, arbitrary outbound network traffic includes advertising web posting messages which are sent to external web blogs and boards. Arbitrary outbound network traffic also includes, for example, DoS attack to outer networks or servers. Any type of arbitrary network traffic may be monitored and controlled with the message control agents described above in the embodiments.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for controlling distribution of messages in a shared hosting environment, comprising:
identifying a sender based on a system identification of the sender wherein the system identification is controllable and accessible in the shared hosting environment;
evaluating properties of a message based on a predetermined rule; and
distributing the message upon compliance of the message with the rule.

2. A method of claim 1, wherein the identifying comprises retrieving the system identification of the sender based on operating system functions.

3. A method of claim 1, wherein the identifying comprises retrieving the system identification of the sender based on internal data structure of an operating system.

4. A method of claim 1, further comprising redirecting data packet by formatting an external destination address of the data packet with an internal destination address.

5. A method of claim 1, wherein the evaluating properties of the message comprises counting a number of messages, a sending rate of messages, a number of recipients, a number of connections, a rate of connections, or a combination thereof.

6. A method of claim 5, further comprising periodically charging the sender based on the count.

7. A method of claim 1, wherein the evaluating properties comprises filtering contents of the messages.

8. A method of claim 1, further comprising tagging the system identification into a data packet generated by the sender.

9. A method of claim 8, further comprising encrypting the tagged system identification with a secret key.

10. A method of claim 9, further comprising sending the data packet having the tagged system identification to a remote control server.

11. A method of claim 10, further comprising verifying the sender by retrieving the system identification from the data packet at the remote control server.

12. A method of claim 1, wherein the distributing comprises authenticating the message with a predetermined key assigned to the shared hosting environment.

13. A method of claim 1, further comprising determining no distribution of the messages upon finding of violation of the rule.

14. A message control system in a shared hosting environment, comprising:
a server shared by a plurality of virtual hosts, the server comprising an identification module which identifies a user ID; and
a message control agent in communication with the identification module and determining distribution of messages based on the user ID;
wherein the user ID is generated at an operating system level of the server and corresponds to a message data packet generator.

15. A message control system of claim 14, wherein the server further comprises:
an application layer storing a plurality of user applications; and
a kernel layer comprising the identification module.

16. A message control system of claim 14, wherein the message control agent is located at one of the application layer and the kernel layer.

17. A message control system of claim 14, wherein the message control agent is located at a remote location.

18. A message control system of claim 14, wherein the server further comprises a redirection module in communication with the message control agent and operable to redirect the message to the message control agent, the message having a different destination address from a destination address of the message control agent.

19. A message control system of claim 14, wherein the identification module operates to tag the user ID with a message data packet.

20. A message control system of claim 19, wherein the message control agent is disposed at one of an application layer of the server and a remote location.

21. A message control system in a shared hosting environment, comprising:
a hosting server including a first layer and a second layer;
an interface operable to export information generated at the second layer into the first layer; and
a message control agent operable to identify a message sender based on the information exported via the interface and evaluate properties of a message, wherein the message control agent is configured to reside at the first layer.

22. A message control system of claim 21, wherein the first layer comprises an application layer and the second layer comprises a kernel layer.

23. A message control system of claim 21, wherein the interface operates to export a user ID associated with an IP and a port number occupied by the message sender.

24. A message control system in a shared hosting environment, comprising:
a server shared by a plurality of virtual hosts;
a first message control agent operable to identify a user ID; and
a second message control agent in communication with the first message control agent and determining distribution of messages based on the user ID.

25. A message control system of claim 24, wherein the first message control agent is located at the server and the second message control agent is remotely located from the server.

26. A message control system of claim 24, wherein the first message control agent provides the second message control agent with data packets having a tagged user ID.

27. A message control system of claim 24, further comprising an interface operable to export and provide the user ID to the first message control agent.

28. A shared hosting system, comprising:
a plurality of users having a first identification and a second identification, wherein the first identification is modifiable by the users and the second identification is transparent to the users;
a hosting server maintaining the second identification associated with the users; and
a message control agent operable to distribute messages upon verification of the users based on the second identification.

29. The shared hosting system of claim 28, wherein the second identification is represented in a form that an operating system is capable of understanding.

30. The shared hosting system of claim 29, wherein the second identification is associated with message data packets that the users generate.

31. The sharing hosting system of claim 28, wherein the messages comprise email messages, Voice Over Internet Protocol (VOIP) messages, Internet Messenger messages, web posting messages, Denial of Service (DoS) messages, or a combination thereof.
